(19) United States
(12) Patent Application Publication
(10) Pub. No.: US 2019/0109370 A1
(43) Pub. Date: Apr. 11, 2019

(54) CONFORMAL MULTIPORT MICROWAVE DEVICE

(71) Applicant: Government of the United States, as represented by the Secretary of the Air Force, Wright-Patterson AFB, OH (US)

(72) Inventors: Naftali Herscovici, Fairborn, OH (US); Lance A. Griffiths, Beavercreek, OH (US)

(21) Appl. No.: 15/873,124

(22) Filed: Jan. 17, 2018

Related U.S. Application Data
(60) Provisional application No. 62/568,966, filed on Oct. 6, 2017.

(51) Int. Cl. H01Q 1/28; H01Q 19/06; H01Q 3/36; H01Q 21/22

(52) U.S. Cl. CPC H01Q 1/28; H01Q 21/22; H01Q 3/36; H01Q 19/062

(57) ABSTRACT

A multiport microwave device for passively steering an antenna includes a substrate, a plurality of array ports on a first side of the substrate, where the array ports are configured for connection to one or more radiating elements, a plurality of beam ports on a second side of the substrate opposite the first side, where the beam ports are configured to transmit a signal received by at least one of the plurality of array ports, and a lens structure on the substrate disposed between the plurality of array ports and the plurality of beam ports, the lens structure configured to provide a phase shift for the signal between the array ports and the beam ports. In the multiport microwave device, the substrate may be rolled about an axis into a final shape having a predetermined radius of curvature in which portions of the multiport microwave device overlap one another.

Pursuant to 37 C.F.R. § 1.78(a)(4), this application claims the benefit of and priority to prior filed co-pending Provisional Application Ser. No. 62/568,966, filed 6 Oct. 2017, which is expressly incorporated herein by reference.

### STATEMENT OF GOVERNMENT INTEREST

The invention described herein may be manufactured, used, and licensed by or for the Government of the United States for all governmental purposes without the payment of any royalty.

### BACKGROUND

A challenge of designing unmanned aerial vehicles (UAVs) may include the limited amount of interior or exterior space for components, e.g., where the communication systems, navigation systems, and radar systems all compete for this limited space. Phased array antenna systems, in turn, may save space, weight, and power by steering an antenna electrically instead of mechanically. In this manner, multiport microwave devices, such as Rotman lens devices, may be particularly efficient in providing predetermined amplitude and phase waveform inputs to a phased array antenna to allow for such steering. However, the generally elongated, flat, planar shape of a Rotman lens may make it cumbersome to fit within the space confines of a UAV. There remains a need for a conformal multiport microwave device, e.g., a Rotman lens that is “rolled-up” to better fit in a space-constrained location, such as on a tail of a UAV, or otherwise on or within a UAV.

### SUMMARY

In an implementation, a multiport microwave device for passively steering an antenna includes a substrate, a plurality of array ports on a first side of the substrate, where the array ports are configured for connection to one or more radiating elements, a plurality of beam ports on a second side of the substrate opposite the first side, where the beam ports are configured to transmit a signal received by at least one of the plurality of array ports, and a lens structure on the substrate disposed between the plurality of array ports and the plurality of beam ports, the lens structure configured to provide a phase shift for the signal between the array ports and the beam ports. In the multiport microwave device, the substrate may be rolled about an axis into a final shape having a predetermined radius of curvature in which portions of the multiport microwave device overlap one another.

In an implementation, a system includes an antenna array and a multiport microwave device. The multiport microwave device may include a substrate, a plurality of array ports on a first side of the substrate, where the plurality of array ports are each configured for connection to the antenna array for receiving a signal from the antenna array, a lens structure on the substrate disposed adjacent to the plurality of array ports, the lens structure configured to provide a phase shift for the signal, and a plurality of beam ports on a second side of the substrate opposite the first side, each of the plurality of beam ports configured to transmit the phase-shifted signal. In the multiport microwave device, the substrate may be rolled about an axis into a final shape having a predetermined radius of curvature in which portions of the multiport microwave device overlap one another when in the final shape.

In an implementation, an aerial vehicle includes a housing, an antenna disposed on the housing, and a multiport microwave device. The multiport microwave device may include a substrate, a plurality of array ports on a first side of the substrate, where the plurality of array ports are each configured for connection to the antenna array for receiving a signal from the antenna array, a lens structure on the substrate disposed adjacent to the plurality of array ports, the lens structure configured to provide a phase shift for the signal, and a plurality of beam ports on a second side of the substrate opposite the first side, each of the plurality of beam ports configured to transmit the phase-shifted signal. In the multiport microwave device, the substrate may be rolled about an axis into a final shape having a predetermined radius of curvature in which portions of the multiport microwave device overlap one another when in the final shape.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals may identify corresponding elements.

FIG. 1 illustrates a multiport microwave device.

FIG. 2 illustrates a multiport microwave device having a planar layout with labeled ports.

FIG. 3 illustrates a system including a conformal multiport microwave device, in accordance with a representative embodiment.

FIG. 4 illustrates a rolled-mesh view of a conformal multiport microwave device, in accordance with a representative embodiment.

FIG. 5 illustrates an aerial vehicle, in accordance with a representative embodiment.

FIG. 6 is a flow chart of a method for making and using a conformal multiport microwave device, in accordance with a representative embodiment

### DETAILED DESCRIPTION

The various methods, systems, apparatuses, and devices described herein may generally include a conformal multiport microwave device, e.g., a multiport microwave device that is “rolled-up” to better fit in a space-constrained location, such as on a tail of an unmanned aerial vehicle (UAV).

While this invention is susceptible of being embodied in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

All documents mentioned herein are hereby incorporated by reference in their entirety. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus and device may be used interchangeably in this text.

In general, the devices, systems, and methods described herein may include a conformal multiport microwave device. It will be understood that the term “conformal” in this context shall include taking a shape other than being planar, which is an example of a standard configuration of a multiport microwave device. Thus, “conformal” in this context may include substantially non-planar, e.g., where a majority of a body of a multiport microwave device does not align along a single plane. For example, a conformal multiport microwave device may include a multiport microwave device that is “rolled-up” to better fit in a space-constrained location, such as on a tail of a UAV, or otherwise on or within a UAV or other vehicle. “Conformal” in this context may also or instead include a shape that conforms to the (non-planar) shape of another object or housing. One skilled in the art will recognize that this can include a plethora of shapes, all of which are intended to be included within the scope of this disclosure.

An example of a multiport microwave device as described herein includes a Rotman lens or a Rotman device, which may also be referred to in the art as a Rotman-Turner lens. The Rotman lens may include similar designs to those originally disclosed in U.S. Pat. No. 3,170,158, which is incorporated by reference herein in its entirety.

In general, a Rotman lens may allow multiple antenna beams to be formed without a need for switches or phase shifters. Antenna elements may be connected to one side of the Rotman lens, and beam ports may be connected to the other side of the Rotman lens. A Rotman lens may be thought of as a quasi-microstrip (or quasi-stripline) circuit where the input ports are positioned such that linear phase shifts can be achieved at the output ports. In a Rotman lens, the ports may be substantially isolated to have a minimal (or no) effect on the loss (or noise) of adjacent beams. For example, a well-designed lens may have just 1 dB of loss.

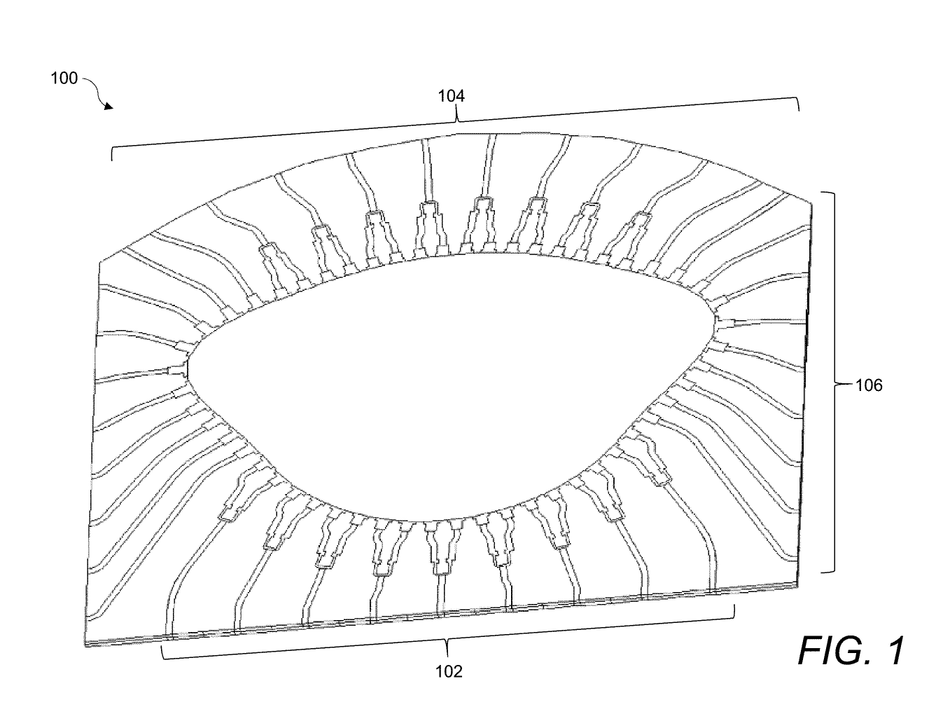

FIG. 1 illustrates a multiport microwave device. Specifically, the figure illustrates a multiport microwave device 100 having a Rotman lens design with nine array ports 102, twelve beam ports 104 for steering a linear array at the X-band range of frequencies, and eight dummy ports 106 on each side of the multiport microwave device 100, e.g., for absorbing energy. As stated above, a Rotman lens such as the multiport microwave device 100 shown in the figure may be used for scanning an antenna array. Radiating elements may be connected to the ports on the transmit side of the lens, where each side on the receiving end corresponds with a scanning direction to make it possible to switch scanning directions by sampling the corresponding port. Such a lens may be relatively low cost compared to electronic scanning systems. The multiport microwave device 100 may be configured for use with a linear array, where the multiport microwave device 100 is inherently a broadband, true time delay feed system, that suffers from a relatively large electrical size.

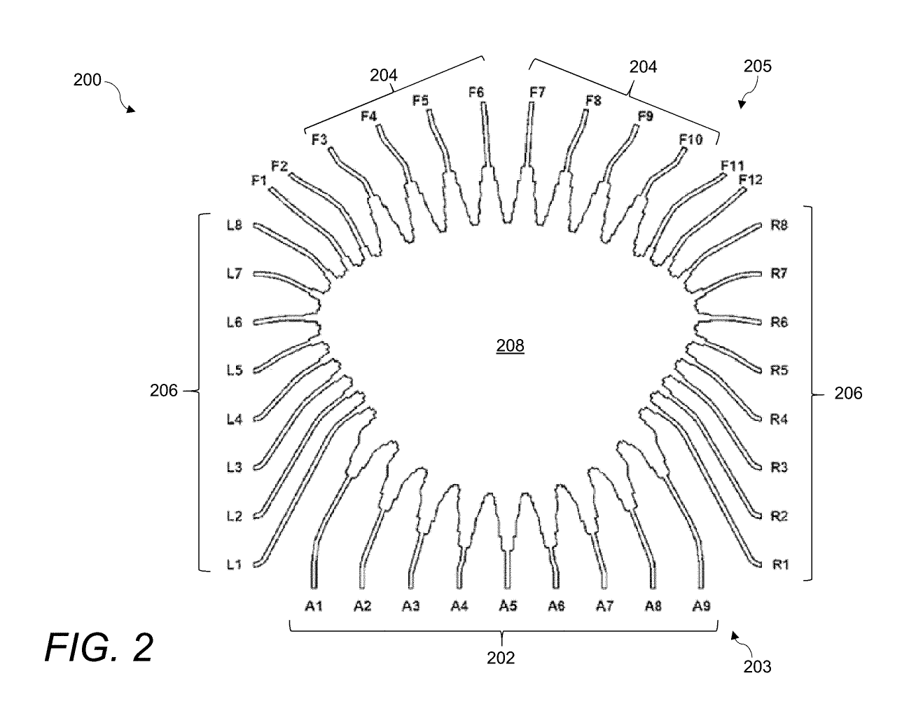

FIG. 2 illustrates a multiport microwave device having a planar layout with labeled ports. The multiport microwave device 200 may be the same or similar to the multiport microwave device 100 described above with reference to FIG. 1. The multiport microwave device 200 may also or instead represent a conformal device according to the present teachings, but before taking its final, conformal shape.

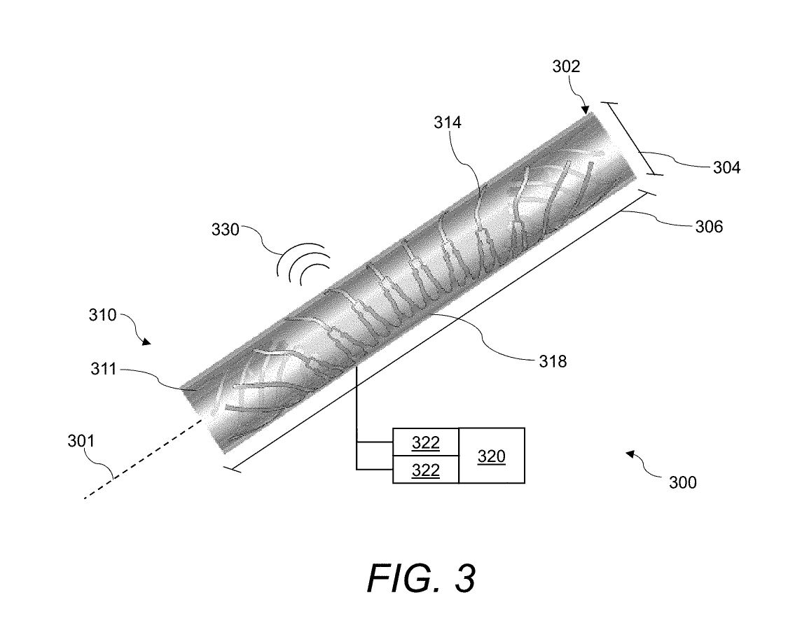

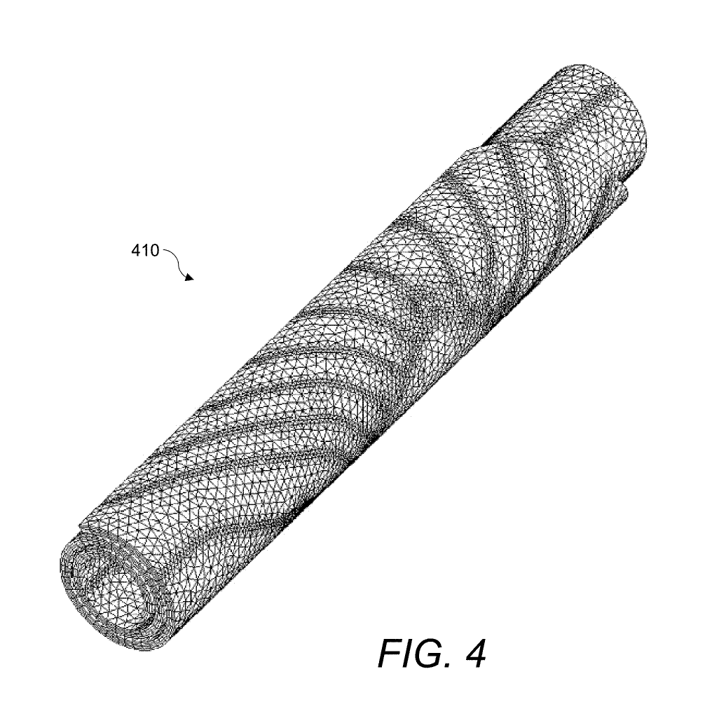

Before being rolled into a final, conformal shape, such as the shape shown in FIGS. 3 and 4, the multiport microwave device 200 may have a substantially planar layout as shown. By way of example, the dimensions of the multiport microwave device 200 may include a length of about 145 mm, a width of about 146 mm, and a height of about 1.54 mm. Other dimensions are of course possible.

The multiport microwave device 200 may thus represent an existing microstrip Rotman lens design that may be converted to a stripline design, which is closer to a closed structure than the microstrip configuration. Converting to a stripline design may be done to avoid mutual coupling in the rolled structure of the final, conformal shape, such as the shape shown in FIGS. 3 and 4.

The multiport microwave device 200 is shown as having nine array ports 202 (labeled A1-A9) on a first side 203 of the device, input ports 204 (labeled F3-F10) on a second side 205 of the device, twenty loaded ports 206 (ten on each side) to absorb reflected energy, and a lens structure 208 for providing a phase shift for a signal between the plurality of array ports 202 and the plurality of input ports 204.

Thus, Rotman lenses of the prior art may include planar microwave devices, having a few wavelengths in the planar plane and a fraction of a wavelength in a third dimension. The design and manufacturing may be relatively precise so that the phasing between various ports is not distorted. To this end, the planarity of the device can help with such precision, but the size in one plane is often quite large when in a planar configuration. Therefore, a conformal multiport microwave device (e.g., Rotman lens) may be desired, where a device such as the multiport microwave device 200 is rolled into a substantially cylindrical spiral, yielding a device that can be mounted within space-constrained locations, such as on a tail of a UAV.

FIG. 3 illustrates a system including a conformal multiport microwave device, in accordance with a representative embodiment. In other words, the system 300 shown in the figure includes a multiport microwave device 310 (e.g., a Rotman lens) that is in a “rolled-up” configuration, and an antenna array 320 engaged therewith. As discussed herein, such conformal Rotman lenses, e.g., having a rolled-up shape with a relatively small radius of curvature but otherwise having a similar makeup to that of relatively planar Rotman lenses, may have similar performance characteristics compared to standard Rotman lenses. In other words, rolling a Rotman lens may not significantly impact its performance, allowing for its use in confined spaces, such as on or within a UAV. In this manner, due to their compact geometry, a conformal multiport microwave device 310 can be embedded on small platforms or otherwise on or within small spaces, empowering users with wideband scanning capabilities where it otherwise may not be feasible or practical.

In general, the multiport microwave device 310 may be used for passively steering an antenna or the like, and may include a substrate 311, a plurality of ports 314 (e.g., array ports, beam ports, and loaded ports as described herein), and a lens structure 318. As shown in the figure, the multiport microwave device 310 may be rolled about an axis 301 into a final shape 302 having a predetermined radius of curvature in which portions of the multiport microwave device 310 overlap one another.

The substrate 311 may be flexible at room temperature, allowing the substrate 311, and thus the multiport microwave device 310, to be rolled about the axis 301 into the final shape 302 having a predetermined radius of curvature in which portions of the multiport microwave device 310 overlap one another. In other implementations, the substrate 311 may be substantially inflexible at room temperature. In such implementations, the substrate 311 may be heated or otherwise treated (e.g., chemically treated) to be rolled into the final shape 302. Regardless, in certain implementations, the multiport microwave device 310 may be substantially fully formed prior to having its shape be manipulated. Thus, the substrate 311, or the entire multiport microwave device 310, may be substantially planar before being rolled about the axis 301. In certain implementations, the substrate 311 may include two layers of Rogers 5880, which may be about 31 mm thick.

The final shape 302 of the multiport microwave device 310 may be substantially cylindrical. The final shape 302 of the multiport microwave device 310 may instead include a converging curve. For example, the final shape 302 may include a spiral, e.g., including without limitation an Archimedean spiral, a Euler spiral, a Fermat's spiral, and so on. Overall, the final shape 302 may be sized and shaped for placement on or within a UAV or other vehicle, e.g., on or within a tail of a UAV.

By way of example and not of limitation, a diameter 304 (e.g., a maximum diameter) of the final shape 302 may be greater than or equal to 20 millimeters and less than or equal to 30 millimeters. Further, by way of example and not of limitation, a length 306 of the final shape 302 may be greater than or equal to 150 millimeters and less than or equal to 170 millimeters. Other sizes are also or instead possible. The final shape 302 may also or instead provide for a few hundredths of wavelengths in the frequency range of operation for the multiport microwave device 310.

Thus, as discussed herein, because the multiport microwave device 310 takes a non-planar shape, it may be able to be used in applications where space is relatively limited, e.g., where other devices of the prior art will not fit. In this manner, the multiport microwave device 310 may be rolled so that it may be used on a smaller footprint. The rolling of the multiport microwave device 310 may be implemented computationally, which can allow for direct manipulation of the vertex coordinates using the formula for calculating the linear length of an Archimedes spiral with angular rotations θ:

$$\begin{matrix}L ( θ ) = \frac{1}{2} a ( θ \sqrt{1 + {θ}^{2}} + ln ( θ + \sqrt{1 + {θ}^{2}} ) ) & Eq . 1 \\ r = a θ & Eq . 2\end{matrix}$$

where r is the radius given the expansion coefficient “a”. In this manner, direct manipulation of the mesh in a computer-aided design program may be used to design the shape for the multiport microwave device 310. It will be understood that Eq. 1 above can represent different spirals/curves such as, but not limited to, Euler, Cornu, and other curves as appropriate to space and manufacturing process limitations.

In certain implementations, the radius of curvature of the multiport microwave device 310 is only limited by the material capabilities used to make the multiport microwave device 310. Thus, if the materials used can sustain a very small curvature radius, the multiport microwave device 310 may function as intended when including such a small radius. In this manner, in certain implementations, the radius of curvature may be made as small as possible given the material capabilities.

As stated above, the multiport microwave device 310 may include a plurality of ports 314—a plurality of array ports on a first side of the substrate 311, and a plurality of beam ports on a second side of the substrate 311, where the second side is disposed opposite the first side. The plurality of array ports may each be configured for connection to one or more radiating elements 322 (e.g., of the antenna array 320), and each of the plurality of beam ports may be configured to transmit a signal 330 received by at least one of the plurality of array ports. Stated otherwise, the plurality of array ports may each be configured for connection to the antenna array 320 for receiving a signal 330 from the antenna array 320, and each of the plurality of beam ports may be configured to transmit the signal 330, e.g., after it is phase shifted by the lens structure 318 described in more detail below. By way of example, the multiport microwave device 310 may include at least eight array ports and at least nine beam ports.

The multiport microwave device 310 may further include a lens structure 318 on the substrate 311 disposed between the plurality of array ports and the plurality of beam ports. For example, the lens structure 318 may be disposed on the substrate 311 adjacent to the plurality of array ports. The lens structure 318 may be configured to provide a phase shift for the signal 330 between the plurality of array ports and the plurality of beam ports. In certain implementations, the lens structure 318 may include a parallel plate or the like.

In this manner, the plurality of array ports, the plurality of beam ports, and the lens structure 318 may define a beamformer, such as a Rotman lens as described herein.

As stated above, the multiport microwave device 310 may further include a plurality of loaded ports disposed between the first side and the second side of the substrate 311. For example, the multiport microwave device 310 may include at least twenty loaded ports.

As discussed herein, the multiport microwave device 310 may include a stripline design, e.g., converted from a microstrip design. Thus, in certain implementations, starting from a microstrip design, the multiport microwave device 310 may be converted to a stripline design and then rolled (e.g., along a spiral path) to yield a geometry that can be easily implemented. Using a stripline design can limit leaks, and can limit the signal interfering with an external environment of the multiport microwave device 310. For example, because the stripline design may have two ground planes that limit the signal to its interior, leaking may be prevented or mitigated, whereas an ‘open structure’ (e.g., having no ground planes, or only one ground plane) may be prone to leaking. Alternatively, the multiport microwave device 310 may include a microstrip design. In certain implementations, the multiport microwave device 310 includes a printed circuit.

FIG. 4 illustrates a rolled-mesh view of a conformal multiport microwave device, in accordance with a representative embodiment. Specifically, the conformal multiport microwave device 410 shown in the figure is shown as a rolled-mesh, such as that included in a computer-aided design application. Manipulation of the mesh may be permitted to form the final shape for the conformal multiport microwave device 410, e.g., manipulation using the Archimedes spiral formula or the like.

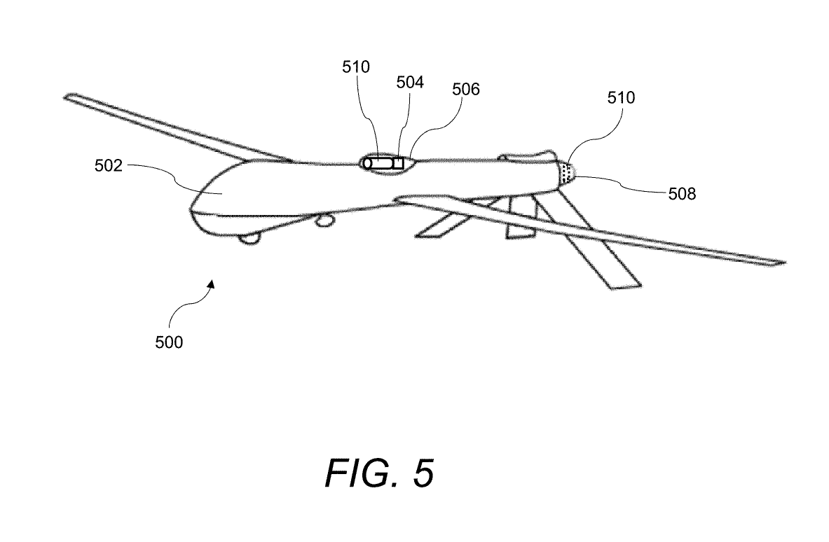

FIG. 5 illustrates an aerial vehicle, in accordance with a representative embodiment. The aerial vehicle 500 may include a housing 502, an antenna 504, and a multiport microwave device 510 according to the present teachings. Because of the inclusion of the multiport microwave device 510 on the aerial vehicle 500, the aerial vehicle 500 may have multibeam capability, which is a feature often missing in some vehicles of the prior art such as UAVs, e.g., because of price, size, and weight constraints.

The housing 502 may include a body of the aerial vehicle 500 or a portion thereof. The housing 502 may also or instead include a separate component to the aerial vehicle 500, e.g., a separate component that is connected to the aerial vehicle 500 or disposed within the aerial vehicle 500. In some implementations, the housing 502 includes a platform 506 or the like disposed thereon or therein, where the platform 506 is engaged with one or more of the antenna 504 and the multiport microwave device 510. The housing 502, or the aerial vehicle 500, may include a tail 508, where one or more of the antenna 504 and the multiport microwave device 510 is disposed on or within the tail 508.

The antenna 504 may be disposed on or within the housing 502. The antenna 504 may also or instead be contained within, or engaged with, the aerial vehicle 500. The antenna 504 is shown by way of representation, and may include any as described herein or otherwise known in the art.

The multiport microwave device 510 may be any as described herein. For example, the multiport microwave device 510 may include a substrate, a plurality of array ports on a first side of the substrate, a lens structure on the substrate disposed adjacent to the plurality of array ports, and a plurality of beam ports on a second side of the substrate opposite the first side. The plurality of array ports may each be configured for connection to the antenna 504 for receiving a signal from the antenna 504, the lens structure may be configured to provide a phase shift for the signal, and each of the plurality of beam ports may be configured to transmit the phase-shifted signal. In the multiport microwave device 510, the substrate may be rolled about an axis into a final shape having a predetermined radius of curvature in which portions of the multiport microwave device 510 overlap one another when in the final shape. Thus, the multiport microwave device 510 may include a “rolled-up” or otherwise conformal device as described herein.

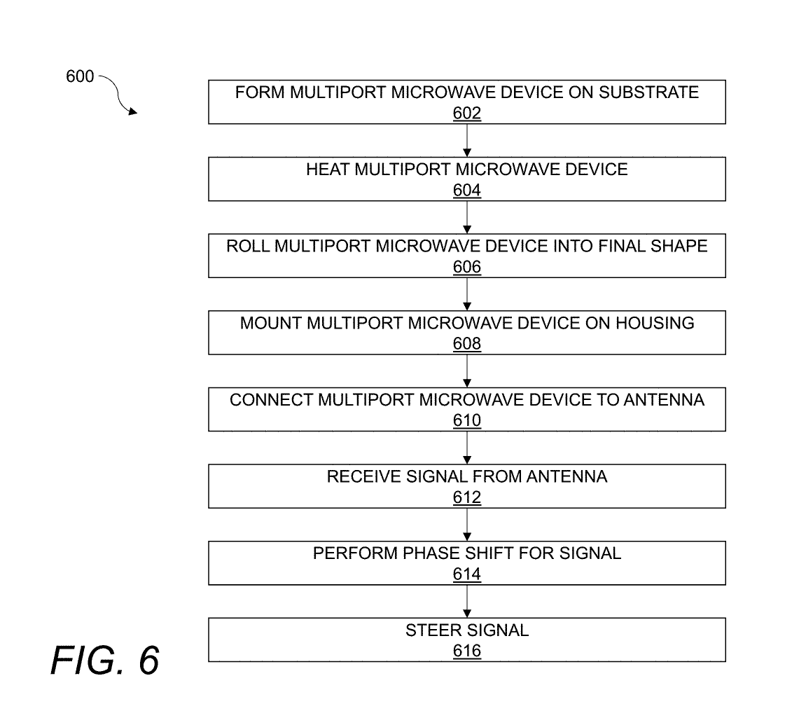

FIG. 6 is a flow chart of a method for making and using a conformal multiport microwave device, in accordance with a representative embodiment. The conformal multiport microwave device may be any as described herein. Thus, the multiport microwave device may include a substrate, a plurality of array ports on a first side of the substrate, where the plurality of array ports are each configured for connection to an antenna for receiving a signal from the antenna, a lens structure on the substrate disposed adjacent to the plurality of array ports, where the lens structure is configured to provide a phase shift for the signal, and a plurality of beam ports on a second side of the substrate opposite the first side, where each of the plurality of beam ports is configured to transmit the phase-shifted signal.

As shown in block 602, the method 600 may include forming a multiport microwave device on a substrate. This may include forming a plurality of array ports on a first side of the substrate, forming a lens structure on the substrate, and forming a plurality of beam ports on a second side of the substrate. Forming one or more of the plurality of array ports, the lens structure, and the plurality of beam ports may include removing at least a portion of the substrate to expose one or more metal layers disposed on the substrate. As such, a method similar to that used to make a printed circuit board may be used to form the multiport microwave device on the substrate.

The method 600 may also or instead include receiving the multiport microwave device, e.g., a prefabricated, planar multiport microwave device. Thus, in some implementations, the multiport microwave device may be prefabricated by a third party and then rolled or otherwise manipulated into a conformal shape, or the multiport microwave device may be manufactured using techniques described herein or otherwise known in the art.

As shown in block 604, the method 600 may include heating the multiport microwave device. The heating of the multiport microwave device may occur before or during rolling of the multiport microwave device into a final shape. In certain implementations, e.g., where a flexible substrate is included on the multiport microwave device, heating or otherwise treating of the multiport microwave device may be omitted.

As shown in block 606, the method 600 may include rolling the multiport microwave device about an axis into a final shape in which portions of the multiport microwave device overlap one another.

As shown in block 608, the method 600 may include mounting the multiport microwave device on a housing. For example, this may include mounting the multiport microwave device on or within a vehicle (e.g., a UAV).

As shown in block 610, the method 600 may include connecting the multiport microwave device to an antenna.

As shown in block 612, the method 600 may include receiving a signal at the multiport microwave device from the antenna.

As shown in block 614, the method 600 may include performing a phase shift for the signal using the multiport microwave device.

As shown in block 616, the method 600 may include steering the signal using the multiport microwave device.

An example simulation will now be discussed. In testing a Rotman lens according to the present teachings, simulations were performed utilizing code implementing the finite element method having a p-level multigrid capability. The example rolled lens was modeled with 16 nodes utilizing a E5-2650 processor running at 2 GHz. The example simulation involved 808 k unknowns and used 12 GB of memory. Input port S-parameters used 136 seconds of simulation time per port and frequency. Using the computed S-parameters, far field patterns were computed analytically for both normal incidence excitation (e.g., port A5 excited) and for a 23-degree scan (e.g., port A1 excited). The results showed that main beam performance was not significantly impacted by the physical form of the lens, and side-lobe levels were only 2 to 5 dB higher compared to a uniform excitation at maximum scan. Thus, these example simulations showed that a rolled lens can be modeled by applying a mesh transformation that converts a flat mesh into a rolled mesh, where simulation results further show that system performance is not significantly impacted by rolling the lens, while size can be reduced significantly, making it possible to mount the lens in a compact space, such as the tail of a small UAV.

As discussed herein, using the present teachings it may be possible to pack the relatively large area of a Rotman lens into a small volume, e.g., by rolling it in a cylinder following a spiral path. Alternatively, the Rotman lens may be folded one or more times.

Although the present teachings may emphasize inclusion of conformal multiport microwave devices on UAVs and the like, other uses are also or instead possible. For example, conformal multiport microwave devices may be used for universal internet wireless base stations, mobile internet services, mobile internet devices, and the like. Stated otherwise, conformal multiport microwave devices described herein may be used wherever traditional antennas would need a significant redesign to use in a space-constrained location such as a small platform.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled, or executed to run on one of the above devices, as well as heterogeneous combinations of processors, processor architectures, or combinations of different hardware and software. In another implementation, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another implementation, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another implementation, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of this disclosure and are intended to form a part of the disclosure as defined by the following claims, which are to be interpreted in the broadest sense allowable by law.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A multiport microwave device for passively steering an antenna, comprising:
a substrate;
a plurality of array ports on a first side of the substrate, the plurality of array ports each configured for connection to one or more radiating elements;
a plurality of beam ports on a second side of the substrate opposite the first side, each of the plurality of beam ports configured to transmit a signal received by at least one of the plurality of array ports; and
a lens structure on the substrate disposed between the plurality of array ports and the plurality of beam ports, the lens structure configured to provide a phase shift for the signal between the plurality of array ports and the plurality of beam ports,
where the substrate is rolled about an axis into a final shape having a predetermined radius of curvature in which portions of the multiport microwave device overlap one another.

2. The multiport microwave device of claim 1, where the final shape is substantially cylindrical.

3. The multiport microwave device of claim 1, where the final shape comprises a converging curve.

4. The multiport microwave device of claim 3, where the converging curve is a spiral.

5. The multiport microwave device of claim 1, where the substrate is flexible at room temperature.

6. The multiport microwave device of claim 1, where the substrate is substantially inflexible at room temperature.

7. The multiport microwave device of claim 6, where the substrate is heated to be rolled into the final shape.

8. The multiport microwave device of claim 1, where the substrate is substantially planar before being rolled about the axis.

9. The multiport microwave device of claim 1, where the final shape is sized and shaped for placement on a tail of an unmanned aerial vehicle (UAV).

10. The multiport microwave device of claim 1, where the plurality of array ports, the plurality of beam ports, and the lens structure define a beamformer.

11. The multiport microwave device of claim 10, where the beamformer is a Rotman lens.

12. The multiport microwave device of claim 1, where the lens structure comprises a parallel plate.

13. The multiport microwave device of claim 1, further comprising a plurality of loaded ports disposed between the first side and the second side of the substrate.

14. The multiport microwave device of claim 1, where the multiport microwave device comprises a stripline design.

15. The multiport microwave device of claim 1, where the multiport microwave device comprises a printed circuit.

16. A system, comprising:
an antenna array; and
a multiport microwave device, comprising:
a substrate;
a plurality of array ports on a first side of the substrate, the plurality of array ports each configured for connection to the antenna array for receiving a signal from the antenna array;
a lens structure on the substrate disposed adjacent to the plurality of array ports, the lens structure configured to provide a phase shift for the signal; and
a plurality of beam ports on a second side of the substrate opposite the first side, each of the plurality of beam ports configured to transmit the phase-shifted signal,
where the substrate is rolled about an axis into a final shape having a predetermined radius of curvature in which portions of the multiport microwave device overlap one another when in the final shape.

17. The system of claim 16, where the final shape of the substrate is substantially cylindrical.

18. The system of claim 16, where the final shape of the substrate comprises a converging curve.

19. The system of claim 18, where the converging curve is a spiral.

20. An aerial vehicle, comprising:
a housing;
an antenna disposed on the housing; and
a multiport microwave device, comprising:
a substrate;
a plurality of array ports on a first side of the substrate, the plurality of array ports each configured for connection to the antenna for receiving a signal from the antenna;
a lens structure on the substrate disposed adjacent to the plurality of array ports, the lens structure configured to provide a phase shift for the signal; and
a plurality of beam ports on a second side of the substrate opposite the first side, each of the plurality of beam ports configured to transmit the phase-shifted signal,
where the substrate is rolled about an axis into a final shape having a predetermined radius of curvature in which portions of the multiport microwave device overlap one another when in the final shape.
